(19) United States
(12) Patent Application Publication
(10) Pub. No.: US 2012/0149354 A1
(43) Pub. Date: Jun. 14, 2012

(54) VEHICLE INFORMATION SYSTEM

(75) Inventors: Yilun Ying, Shanghai (CN); Liang Huo, Shanghai (CN); Yu Jiang, Shanghai (CN); Xing Liu, Shanghai (CN); Yu Yao, Shanghai (CN); Zhihong Zhang, Shanghai (CN); Dawei Zhu, Shanghai (CN); Yehui Zhang, Shanghai (CN); Yang Luan, Shanghai (CN); Song Yang, Shanghai (CN)

(73) Assignees: Shanghan PATEO Internet Technology Service Co., Ltd., Shanghai (CN); Shanghai PATEO Electronic Equipment Manufacturing Co., Ltd., Shanghai (CN)

(21) Appl. No.: 13/391,747

(22) PCT Filed: Dec. 25, 2010
(86) PCT No.: PCT/CN10/80281

§ 371 Date: Feb. 22, 2012

(30) Foreign Application Priority Data
Dec. 31, 2009 (CN) 200910247984

(51) Int. Cl. H04W 4/04; H04W 4/18; G06F 15/177

(52) U.S. Cl. 455/418; 709/220

(57) ABSTRACT

A vehicle information system includes: a vehicle-mounted device, a network processing device and a service center which is adapted for providing service for the vehicle-mounted device. A service configuration channel is configured between the network processing device and the service center and is adapted for transmitting configuration data which are adapted for configuring service that is provided for the vehicle-mounted device. The service configuration channel is established on basis of connection to internet. A service channel system is configured between the vehicle-mounted device and the service center. A complete solution for providing information service may be provided by the vehicle information system, thereby improving the quality of user experience while using a vehicle.

### CROSS REFERENCE TO RELATED APPLICATIONS

The present application claims the priority of Chinese Patent Application No. 200910247984.2, entitled “Vehicle Information System”, and filed on Dec. 31, 2009, the entire disclosure of which is incorporated herein by reference.

### BACKGROUND OF THE INVENTION

1. Field of the Invention

The present invention relates to the field of vehicle electronic technology, and particularly relates to a vehicle information system.

2. Background of the Invention

Nowadays, vehicle industry is developing rapidly, and the quantity of vehicles is continuously increasing. When using a vehicle, people pay more attention to the user experience. Multimedia information such as music, video and pictures, and driving information such as real-time state of road information and maps of destinations are required.

In prior art, driving information can be provided by GPS (Global Position System) navigation devices, and needs for multimedia information such as music, video and pictures can be met by playing optical disks which contain these multimedia information. Updating of these multimedia information may be usually realized by changing the disks, however, real-time updating may not be achieved.

Currently, some multimedia entertainment systems, in which Bluetooth technique is adopted, are mounted in vehicles. For example, a multimedia playing device is disclosed in Chinese Patent No. 200720171205.1, wherein a vehicle-mounted audio/video playing device may play audio/video which is obtained from an external Bluetooth terminal by using Bluetooth technique. However, the multimedia playing device can not provide a real-time multimedia information service for the vehicle users. Further, as it is realized based on Bluetooth technique, the coupling method thereof is limited.

Besides, there is no complete solution for providing diverse information services during vehicle operation.

### SUMMARY OF THE INVENTION

An object of the invention is to provide a vehicle information system, which offers a complete solution for providing real-time information service while using a vehicle.

To achieve the objection, an embodiment of the present invention provides a vehicle information system, including: a vehicle-mounted device, a network processing device and a service center which is adapted for providing service for the vehicle-mounted device.

A service configuration channel is configured between the network processing device and the service center and is adapted for transmitting configuration data which are adapted for configuring service that are provided for the vehicle-mounted device. The service configuration channel is established on basis of connection to internet.

A service channel system is configured between the vehicle-mounted device and the service center.

Compared with prior art, the vehicle information system according to embodiments of the present invention has the following advantages. The service provided to the vehicle-mounted device from the service center is configured by the network processing device. The service which may be provided by the service center may be configured in advance according to possible needs of the vehicle users or obtained by gathering relevant information of the vehicle users. Thereafter, the vehicle-mounted device may obtain the configured service which is provided in real-time by the service center through the service channel system. Therefore, a complete solution for providing real-time information service may be provided by the vehicle information system, thereby improving the user experience while using a vehicle.

### BRIEF DESCRIPTION OF THE DRAWINGS

FIG. 1 is a schematic diagram of a vehicle information system according to an embodiment of the present invention;

FIG. 2 is a schematic diagram of an example of a vehicle information system according to an embodiment of the present invention;

FIG. 3 is a schematic diagram of a mobile communication network device in the vehicle information system shown in FIG. 2 according to an embodiment of the present invention; and

FIG. 4 is a schematic diagram of a communication unit of a vehicle-mounted device in the vehicle information system shown in FIG. 2 according to an embodiment of the present invention;

### DETAILED DESCRIPTION OF THE EMBODIMENTS

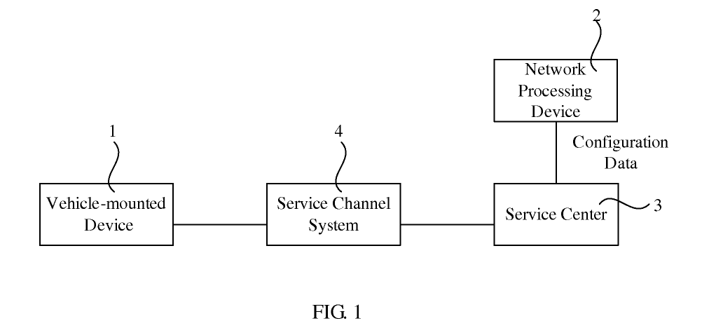

Referring to FIG. 1, a vehicle information system according to an embodiment of the present invention includes: a vehicle-mounted device 1, a network processing device 2 and a service center 3 which is adapted for providing service for the vehicle-mounted device 1.

A service configuration channel is configured between the network processing device 2 and the service center 3, and is adapted for transmitting configuration data which are adapted for configuring service provided for the vehicle-mounted device 1. The service configuration channel is established on basis of connection to internet.

A service channel system 4 is configured between the vehicle-mounted device 1 and the service center 3.

As an embodiment, the network processing device 2 acts as a service requesting terminal of the vehicle information system, the service center 3 acts as a service providing terminal of the vehicle information system, and the vehicle-mounted device 1 acts as a service receiving terminal of the vehicle information system. Specifically, the service which is provided from the service center 3 to the vehicle-mounted device 1 is determined by the network processing device 2 according to the configuration data. Thereafter, the vehicle-mounted device 1 obtains the corresponding service which is provided by the service center 4 through the service channel system 4.

Hereinafter, the aforesaid vehicle information system is further illustrated in an example accompany with attached drawings.

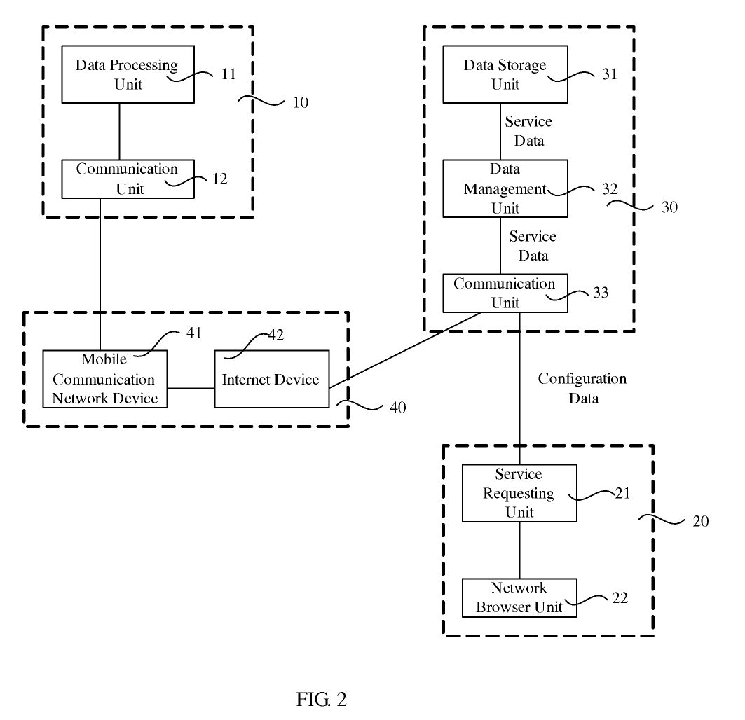

Referring to FIG. 2, in an example of a vehicle information system according to an embodiment of the present invention, a vehicle-mounted device 10 may include:

A communication unit 12, adapted for interchanging data between the vehicle-mounted device 10 and a service center 30; and

A data processing unit 11, adapted for processing data which are to be transmitted to the service center 30, and receiving and processing data from the service center 30.

A service channel system 40 may include:

A mobile communication network device 41, adapted for coupling the vehicle-mounted device 10 to internet; and an internet device 42, adapted for establishing connection between the vehicle-mounted device 10 and the service center 30.

A network processing device 20 may include:

A service requesting unit 21, adapted for transmitting a service request to the service center 30; and a network browser unit 22 which provides a network interface to access the service requesting unit 21.

The service center 30 may include:

A communication unit 33, adapted for interchanging data between the service center 30 and the network processing device 20 or between the service center 30 and the vehicle-mounted device 10;

A data storage unit 31, adapted for storing service data; and

A data management unit 32, adapted for acquiring the service data in the data storage unit 31 according to configuration data, and transmitting the service data to the vehicle-mounted device 10.

Specifically, when a vehicle user needs information service, an access to the service requesting unit 21 is established through the network browser unit 22, and configuration data which contain a service request are transmitted to the service center 30 through the service requesting unit 21. The configuration data which contain the service request are transmitted to the data management unit 32. Upon obtaining the service request, the data management unit 32 acquires corresponding service data from the data storage unit 31 and transmits the service data through the communication unit 33. The service data which are in response to the service request are finally transmitted to the vehicle-mounted device 10. The service data stored in the data storage unit 31 may be configured in advance according to the possible needs of the vehicle user. For example, if the user needs GPS navigation service, the service data may include data of map, real-time state of road and road book. If the user needs multimedia entertainment service, the service data may include data of music, video and pictures and so on. If the user needs information of vehicle operation, the service data may include data of vehicle operation course and vehicle driving record.

As an example, if the vehicle users need GPS navigation service, the data management unit 32 would acquire and transmit the map data, the real-time state of road data and the road book data corresponding to the user's destination from the data storage unit 31.

Further, the vehicle-mounted device 10 is coupled with the service center 30 through the service channel system 40, so that the vehicle-mounted device 10 may obtain the service data which are provided by the service center 30.

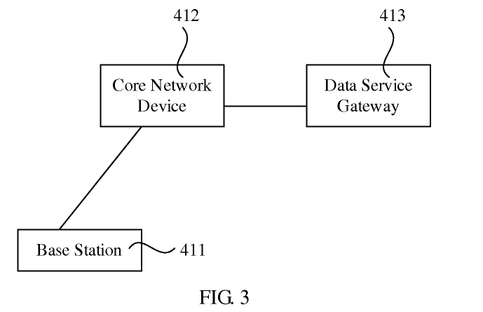

Referring to FIG. 3, the mobile communication network device may include: a base station 411, a core network device 412 and a data service gateway 413.

Referring to FIG. 2 in conjunction with FIG. 3, a request for accessing to internet is transmitted by the vehicle-mounted device 10 through the communication unit 12. Upon obtaining the request, the base station 411 transmits the request to the core network device 22. The core network device 22 couples the vehicle-mounted device 10 to internet through the data service gateway 23 after a relevant process. Then the service center 30 is coupled to internet through the communication unit 33. Generally, the communication unit 33 may be an internet interface device such as a router, and the like. Thereafter, the internet device 42 couples the vehicle-mounted device 10 which is already on the internet to the service center 30. So that a data interchange may occur between the vehicle-mounted device 10 and the service center 30.

Since the vehicle-mounted device 10 is coupled to internet through the mobile communication network device, accordingly, the data interchange between the vehicle-mounted device 10 and the service center 30 is implemented by the mobile communication network device. Therefore, the format of the data which are transmitted from the vehicle-mounted device 10 to the service center 30 should be in compliance with mobile communication network transmission protocols. Moreover, the data formats which are recognizable to the vehicle-mounted device 10 may not comply with the data formats which are in compliance with the mobile communication network transmission protocols. Therefore, the service data format needs to be transformed in order to be recognizable to the vehicle-mounted device. The transforming of the data format is performed by the communication unit 12 in the vehicle-mounted device 10.

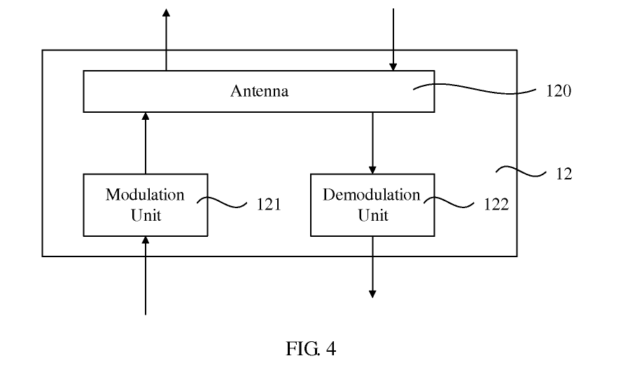

Referring to FIG. 2 in conjunction with FIG. 4, the communication unit may include:

An antenna 120;

A modulation unit 121, adapted for transforming the data format of the data which are to be transmitted to the service center 30 into a data format which is in compliance with the mobile communication network transmission protocols and transmitting the data through the antenna 120; and

A demodulation unit 122, adapted for transforming the data format of the data from the service center 30 into the data format which is recognizable to the vehicle-mounted device.

As an example, if the mobile communication network is a 2.5G network, the modulation unit 121 needs to transform the format of the data which are to be transmitted to the service center 30 into a data format which is in compliance with the 2.5G network transmission protocol, such as a data format which is in compliance with the GPRS protocol.

And the demodulation unit 122 needs to transform the data, with a data format in compliance with the 2.5G network transmission protocol, into data with a data format which is recognizable to the vehicle-mounted device. Service data which are adapted for playing video are transformed into documents with an existing mainstream video format, for example, “.rm”, “.avi”, or “.mkv”. Service data which are adapted for playing audio are transformed into documents with an existing mainstream audio format, for example, “.mp3”, “.wav”, or “.wma”. Service data which are adapted for showing pictures are transformed into documents with an existing mainstream picture format, for example, “.bmp”, “.jpeg”, or “.gif”.

In conclusion, in the vehicle information system according to the embodiments of the present invention, the service provided for the vehicle-mounted device by the service center is configured by the network processing device. The service which may be provided by the service center may be configured in advance according to possible needs of the vehicle users or obtained by gathering relevant information of the vehicle users. Thereafter, the vehicle-mounted device obtains the configured service which is provided in real-time by the service center through the service channel system. Therefore, a complete solution for providing real-time information service may be provided by the vehicle information system, thereby improving the quality of user experience while using a vehicle.

Although the present invention has been disclosed as above with reference to preferred embodiments, it is not intended to limit the present invention. Those skilled in the art may modify and vary the embodiments without departing from the spirit and scope of the present invention. Accordingly, the scope of the present invention shall be defined in the appended claims.

1. A vehicle information system, comprising: a vehicle-mounted device, a network processing device and a service center which is adapted for providing service for the vehicle-mounted device;
a service configuration channel, configured between the network processing device and the service center, and adapted for transmitting configuration data which are adapted for configuring service which is provided for the vehicle-mounted device, and established on basis of connection to internet; and
a service channel system, configured between the vehicle-mounted device and the service center.

2. The vehicle information system according to claim 1, wherein the network processing device comprises: a service requesting unit, adapted for transmitting service requests to the service center, wherein the service center provides the service for the vehicle-mounted device according to the service requests from the service center.

3. The vehicle information system according to claim 2, wherein the network processing device further comprises a network browser unit.

4. The vehicle information system according to claim 1, wherein the service channel system comprises: a mobile communication network device, adapted for coupling the vehicle-mounted device to internet; and an internet device, adapted for establishing connection between the vehicle-mounted device and the service center.

5. The vehicle information system according to claim 4, wherein the mobile communication network device comprises: a base station, a core network device and a data service gateway.

6. The vehicle information system according to claim 4, wherein the mobile communication network device is a 2.5G, 3G or 4G mobile communication network device.

7. The vehicle information system according to claim 4, wherein the vehicle-mounted device comprises:
a communication unit, adapted for interchanging data between the vehicle-mounted device and the service center; and
a data processing unit, adapted for processing data which are to be transmitted to the service center, and receiving and processing data from the service center.

8. The vehicle information system according to claim 7, wherein the communication unit comprises a modulation unit and a demodulation unit, wherein the modulation unit is adapted for transforming the format of data which are to be transmitted to the service center into a data format which is in compliance with mobile communication network transmission protocols, and the demodulation unit is adapted for transforming the format of data which are from the service center into a data format which is recognizable to the vehicle-mounted device.

9. The vehicle information system according to claim 4, wherein the service center comprises:
a communication unit, adapted for interchanging data between the service center and the vehicle-mounted device or between the service center and the network processing device;
a data storage unit, adapted for storing service data; and
a data management unit, adapted for acquiring the service data from the data storage unit according to the configuration data and transmitting the service data to the vehicle-mounted device.

10. The vehicle information system according to claim 9, wherein the service data comprises data of map, real-time state of road, road book, music, video, picture, vehicle operation course and vehicle driving record.
